(19) United States
(12) Patent Application Publication
(10) Pub. No.: US 2015/0298532 A1
(43) Pub. Date: Oct. 22, 2015

(54) Removable Cover For Automobiles

(71) Applicant: Stephen DeRoche, St. Paul, MN (US)

(72) Inventor: Stephen DeRoche, St. Paul, MN (US)

(21) Appl. No.: 14/693,102

(22) Filed: Apr. 22, 2015

Related U.S. Application Data
(60) Provisional application No. 61/982,374, filed on Apr. 22, 2014.

(51) Int. Cl. B60J 11/06

(52) U.S. Cl. CPC B60J 11/06

(57) ABSTRACT

A cover for automobiles is provided that includes a cover with connection devices mounted around or within the exterior of the cover. The cover is dimensioned to cover an open area of the automobile, for instance, a cockpit of a convertible automobile. The connection devices may be a series of magnets covered in a micro-fiber cloth that will not interrupt the magnetic force between the cover and the automobile, but will protect the surfaces of the automobile from any unwanted contact between the magnets and the surfaces of the automobile that may result in scratches or other damage. The cover may be lightweight and customizable, and can quickly and easily be installed or removed from the automobile.

### CROSS-REFERENCE TO RELATED APPLICATION

This application claims priority from U.S. Provisional Patent Application Ser. No. 61/982,374, filed on Apr. 22, 2014, the entirety of which is expressly incorporated herein by reference.

### FIELD OF THE INVENTION

The present invention relates generally to a cover for an automobile and more specifically to a cover for use with a convertible automobile.

### BACKGROUND OF THE INVENTION

Convertible automobiles feature a variety of hard and soft top options that allow the user to enjoy both a closed top vehicle during cold temperatures or other adverse weather conditions and an open top vehicle when the weather is warm. Many newer convertible automobile tops can be quickly and easily raised and lowered with minimal effort. However, many older convertible automobiles require an increased effort to raise and lower the top. Some models include complicated hydraulic systems in combination with a series of manual latches or other fastening mechanisms. Especially with older vehicles, the material forming the convertible top can be dated and/or worn and increased care must be taken to avoid ripping or puncturing the material. Additionally, many automobile models require the top to be carefully folded and packed whenever lowered. Further, some convertible tops require the user to move from side to side around the car repeatedly to adjust the top and engage or disengage the connector devices of each side as the top is raised or lowered.

These many components and lengthy procedures for raising and lowering the convertible top can cause users to leave the top down whenever possible. However, it is often advantageous to cover the vehicle when not driving, even if the stop is only for a brief period of time. For instance, many individuals prefer to raise their automobile's top to avoid exposure of the interior of the vehicle to the sun and UV rays. This is especially true for older vehicles that have valuable original interiors or restored or new vehicles with expensive new or reproduction interiors. Also, failure to raise the top may expose the interior of the automobile to unwanted dust and dirt, Additionally, the interior surfaces, such as the seats and steering wheel, can reach excessive temperatures on a sunny day which are uncomfortable for the driver and passengers to contact, or in extreme cases my cause skin burns. Furthermore, users will typically want to quickly cover their convertible when a sudden and unexpected rain storm blows in. Moreover, a convertible that is covered is less likely to be approached by thieves or vandals.

To address many of these issues, temporary convertible covers have been introduced in a number of forms. For instance, some temporary convertible covers use bungees, cords, rods, hooks, straps, and other types of connectors to secure a temporary cover. Some covers require additional pieces or fasteners that are installed directly onto the surface of the convertible, which may be unappealing, especially for collector vehicles. The majority of these temporary covers can typically be installed more quickly than by raising the automobile's permanent top. However, there is risk that the connecting pieces may scratch the exterior paint or damage the interior of the automobile or that permanent alteration of the vehicle decreases value or creates initiation points for corrosion.

The majority of these covers attach to the automobile around the perimeter of the cockpit area of the convertible, and up and around the windshield. Oftentimes, this configuration increases the likelihood that the material of the cover may move, flap or be removed entirely from the vehicle in the wind. Flapping or increased movement of the cover may result in scratches or other damage to the vehicle. Another frequent issue is that loose-fitting and flapping vehicle covers may be visually unappealing.

As a result, it is desirable to develop a cover for a convertible automobile that can be quickly installed underneath the windshield of the convertible without risk of damage to the automobile in a variety of weather conditions.

### SUMMARY OF THE INVENTION

According to one aspect of an exemplary embodiment of the present disclosure, a cover for a vehicle is made of a lightweight material. The cover may be made of a micro-fiber cloth to avoid damage or scratching on any surfaces of the vehicle.

According to another aspect of an exemplary embodiment of the present disclosure, the cover may be used with a convertible automobile. The cover is dimensioned to cover the cockpit area of the convertible when the top of the convertible top is lowered. In one embodiment the cover will fit around the edge of the cockpit area, and under the windshield of the automobile. To securely attach the cover to the convertible, the cover may have a plurality of magnets located throughout or along the periphery of the cover. In one embodiment, the magnets are flat extruded magnets that are sewed in or along and enclosed by the edges of the cover. In an alternate embodiment, the magnets are high strength magnets that are positioned around each corner of the cover.

According to another aspect of an exemplary embodiment of the present disclosure, the cover may be made of a clear material. This will allow individuals to see the interior of the convertible while the cover is on. The clear material may be UV opaque, which will prevent fading and damage of the interior due to the sun.

According to yet another aspect of an exemplary embodiment of the present disclosure, the cover may have a plurality of vent holes formed therein. Alternatively, the cover may be made of a mesh material. Both options result in a cover that allows air movement through the cover in order to prevent the air in the interior of the vehicle under the cover from becoming “stale”.

Numerous other aspects, features, and advantages of the present disclosure will be made apparent from the following detailed description together with the drawings figures.

### BRIEF DESCRIPTION OF THE DRAWINGS

The drawings illustrate the best mode currently contemplated of practicing the present disclosure.

In the drawings:

FIG. 1 is a perspective view of an exemplary embodiment of the inventive removable cover for automobiles constructed according to the present disclosure;

FIG. 2 is a partially broken away isometric view of the magnet located within the inventive removable convertible cover about line 2-2 of FIG. 1;

FIG. 3 is a perspective view of another embodiment of the inventive removable cover for automobiles; and

FIG. 4 is a perspective view of the inventive removable cover of FIG. 3.

### DETAILED DESCRIPTION OF THE INVENTION

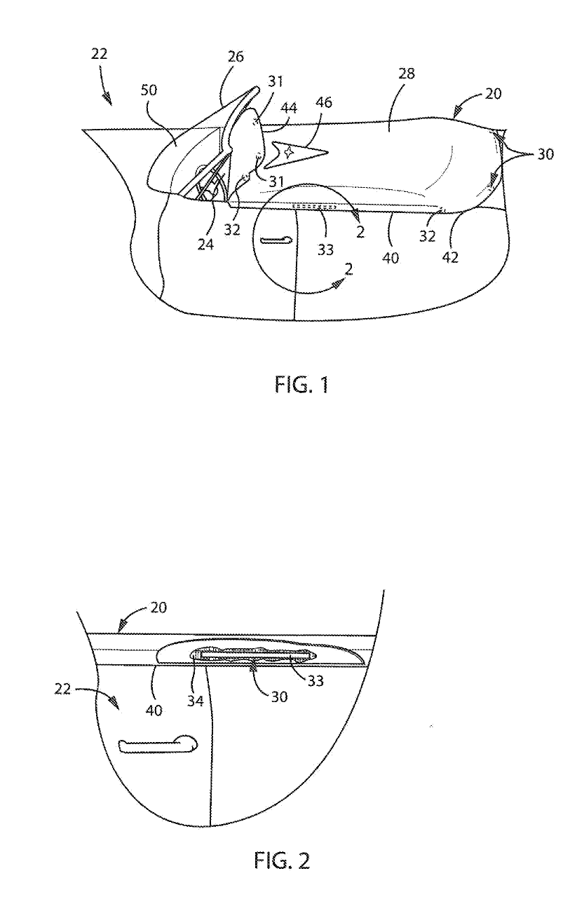

Referring now in detail to the drawing figures, wherein like reference numerals represent like parts throughout the several views, two exemplary embodiments of a cover 20 according to the present disclosure is illustrated generally in FIGS. 1-4.

The cover 20 provides a covering for an automobile or other vehicle that can quickly and easily be applied and removed. The cover 20 is made of a generally lightweight material such that it can easily be installed onto an automobile by a single individual. As shown, the cover 20 has a generally rectangular shape conforming to the shape of an automobile 22 or other vehicle on which the cover 20 is to be positioned, and has a leading edge 44, multiple side edges 40, and four corners 42. Other configurations could be used depending on the type and size of automobile and the type of covering or protection desired. In the illustrated embodiment, the cover 20 is for use with a convertible automobile 22, and more specifically to cover the open interior or cockpit 24 of the convertible automobile 22. Thus, the cover 20 has a footprint that mimics, but is slightly larger than, the perimeter of the open cockpit 24 of the automobile 22. The cover 20 can be installed onto the convertible automobile 22 when the top 28 of the convertible automobile 22 is in a lowered or collapsed position. This allows the cockpit 24 of the convertible to be sheltered from weather and dust. Furthermore, a covered automobile 22 is generally less susceptible to theft either of the automobile 22 or of items (not shown) present in the interior cockpit 24 of the automobile 22.

In addition, the inventive cover 20 need not be designed exclusively for convertible automobiles 22. Rather, the cover 20 may be altered in shape to be usable with any type of vehicle as would be known to one skilled in the art. For instance, the cover 20 could be used to cover open cockpit sports utility vehicles. Also, the cover 20 could be used with T-top vehicles. Further, the cover 20 could be used to cover an entire motorcycle. Moreover, the cover 20 could be designed to cover merely the seat of the motorcycle to prevent the temperature rise of the surface where the operator sits. Further still, a larger cover 20 could be used to provide covering for a traditional automobile. Such a cover 20 could be draped over the windows of the vehicle, or it could extend down the sides of the vehicle.

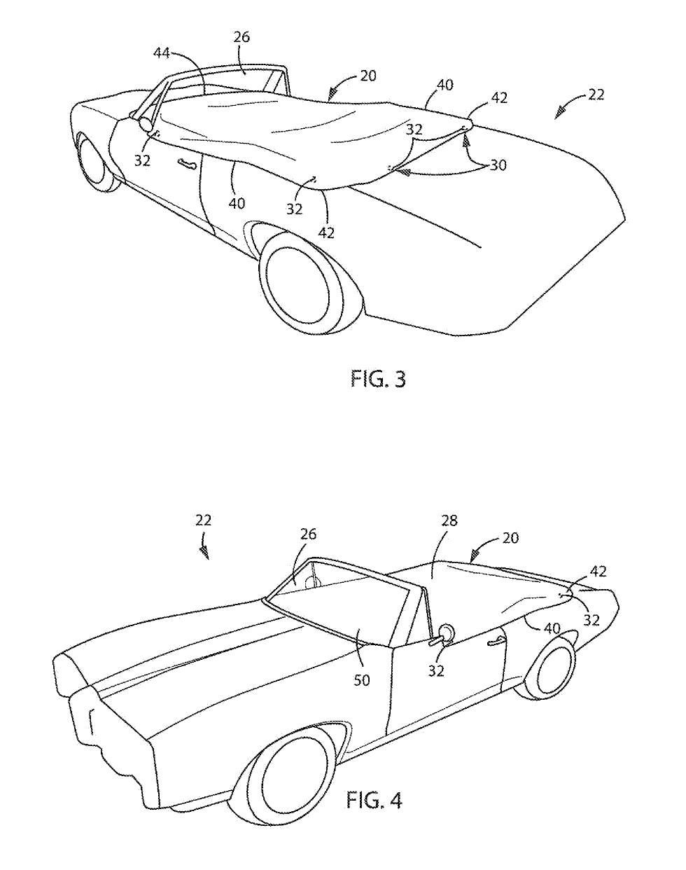

Looking now at FIG. 1, the cover 20 has a plurality of connector devices 30 that allow it to be releasably-installed in a quick and easy manner to the automobile 22. For instance, the cover 20 may be installed onto the automobile 22 using magnets 32, 33. As would be appreciated by one skilled in the art any variety of different magnetic configurations could be incorporated into the cover 20. As shown in FIGS. 1-2, the cover 20 may have a plurality of flat, extruded magnets 33 that are positioned along the sides 40 of the cover 20. These flat, extruded magnets 33 may be sewn into the side edges 40 of the cover 20. FIG. 2 provides a detailed cut-away view of a flat, extruded magnet 33 located between the cover 20 and a micro-fiber cloth 34 as will be described below. The magnetic connection between the flat, extruded magnets 33 and the sides of the convertible automobile 22, along with the weight of the flat, extruded magnets 33, help to secure a tight fitting connection that will resist movement of the cover 20 as a result of wind or unintentional contact with the cover 20. Alternatively, or in conjunction with the fiat, extruded magnets 33, high strength magnets 32 may be installed at or along the corners 42 of the cover or installed periodically around the edges of the cover. FIG. 1 illustrates a cover 20 that includes both flat, extruded magnets 33 and high strength magnets 32 whereas FIGS. 3-4 feature an alternate design where only high strength magnets 32 are mounted at the corners 42 of the cover 20. Whether the cover 20 includes the flat, extruded magnets 33 located on the side edges 40 of the cover 20 and/or the high strength magnets 32 located at the corners 42 of the cover 20, the cover 20 will be securely fitted to the convertible automobile 22 by the engagement of the magnets 32 with the metal forming the automobile 22. This will prevent risk of flapping or other movement of the cover 20 which may result in damage to the convertible automobile 22, or the complete removal and loss of the cover 20 in the wind. Additionally, a combination of both types of magnets 32, 33 may be used in any suitable configuration. As shown, the magnets 31, 32, 33 are shown in phantom because they are located within the cover 20 or between the cover 20 and a micro-fiber cloth 34 secured to the cover 20 around the magnets 31, 32, 33 to prevent damage to the exterior of the automobile 22.

Still looking to FIG. 1, the cover 20 is illustrated with the leading edge 44 of the cover lifted up to expose the interior cockpit 24. The leading edge 44 of the cover may contain additional dashboard magnets 31 that engage the dashboard 50 of the automobile 22 when the dashboard 50 is metallic. As such, the leading edge 44 can releasably engage the dashboard 50 to fully cover the interior cockpit 24 while keeping the cover 20 beneath the windshield 26. The resulting cover 20 will lay flat and be tight fitting about the cockpit 24 of the convertible automobile 22. Other leading edge 44 connector devices may be used where the dashboard 50 is not metallic. Once applied, the cover 20 will prevent wind and debris from entering under the interior cockpit 24 and causing movement or flapping of the cover 20 about the convertible automobile 22. Furthermore, a cover 20 that fits tightly and cleanly over the automobile cockpit 24 is visually appealing and accentuates the figure of the automobile 22.

In an alternative exemplary embodiment, the cover 20 is secured to the automobile 22 using weights (not shown). For instance, instead of or in conjunction with the magnets 32, 33 the weights can be incorporated along the side edges 40 of the cover 20. Preferably, the weights are surrounded by a scratch resistant material to avoid potential damage to the vehicle and its paint. Additionally weights may be mounted within the corners 42 of the cover. Further still, a weight may be located adjacent to the leading edge 44 such that the leading edge 44 of the cover 20 is secured beneath the vehicle windshield. Other weights could be located around the cover 20 to ensure the cover 20 is reliably secured to the automobile. Different weights could be used depending on the weight and thickness of the cover material to ensure that the cover 20 is securely mounted over the interior cockpit 24 of the automobile 22.

In still another exemplary alternative embodiment, high friction materials (not shown) secured to the cover 20 may be used to frictionally engage the various exterior surfaces of the automobile 22, either separately from or in conjunction with the magnets 32. For example, materials such as printed silicone or rubber strips or patterns and be placed on a lower surface of the cover 20 to frictionally engage the surface of the automobile 22. In addition, hooks (not shown) or other similar engaging structures capable of releasably engaging vents or other structures on the automobile 22 can be attached to the cover 20 to be used separately from or in conjunction with the magnets 32 to secure the cover 20 to the automobile 22, as well as any other suitable engaging means.

As would be appreciated by one skilled in the art, any combination of the suggested connector devices 30 could also be used, including magnets 31, 32, 33 weights, and high friction materials could be used with the cover.

The cover 20, in one exemplary embodiment, is made of a lightweight yet durable material, for example, such as nylon, canvas, vinyl, acrylic, polyethylene, PVC, muslin, or similar materials or combinations thereof The cover 20 may be made of a material with vents or small open holes (not shown) of any suitable configuration located throughout the cover 20, or at strategic locations to encourage air movement into and out of the interior 24 of the automobile 22 without degrading the functionality of the cover 20. In an alternative exemplary embodiment, the cover 20 may be made in part or entirely of a water-proof, but air-permeable or breathable mesh. This increased air movement through the cover 20 assists in prevention of condensation on the underside of the cover 20 which may occur if the interior of the cockpit 24 is covered during a significant outside temperature cycle, such as day to night.

In still other exemplary embodiments, the connector devices 30 may be covered by a variety of scratch resistant materials to prevent the connector devices from coming into direct contact with the vehicle or automobile 22. For instance, a micro-fiber cloth 34 may be sewn or otherwise secured onto the underside of the cover 20 and around the connector device 30 to ensure that vehicle 22 is not scratched or otherwise damaged by direct contact of the connector device 30 with the automobile 22, as can be seen in detail in FIG. 2. The cloth 34 may form a pocket or other opening within which various connector devices 30, for instance magnets 32 or weights, can be inserted or removed. This would allow the connector devices 30 to be removed from the cover 20 to enable the cover 20 to be cleaned or washed. Alternatively, the connector devices 30 may be permanently connected to the cover 20, for instance, by sewing the cloth 34 completely around the connector devices 30, or in the case of the extruded magnet 33 the cloth 34 may be secured by sewing through the cloth 34, magnet 33 and cover 20. Alternatively, the connector devices 30 may be held with adhesive to the cloth 34 or cover 20, thereby fixing the position of the devices 30 on the cover 20.

The cover 20 may feature various designs 46, such as logos, messages advertisements, and other graphics. This allows a user to personalize the appearance of the automobile 22 via the design 46 of the cover 20 without having to make permanent changes to the automobile 22. Alternatively, the cover 20 can be made of a transparent material, such as PVC. This would allow individuals to see the interior of the automobile 22 while the cockpit 24 is still isolated and protected from the elements by the cover 20. This would be especially useful at auto shows where the interior cockpit 24 of the automobile 22 is displayed and protected simultaneously. In one exemplary embodiment, the transparent material can be UV opaque such that the interior of the cockpit 24 is not exposed to damaging sunlight. Additionally, the cover 20 can have a water diverter hole or device (not shown) such that captured rain water drains away from the interior of the automobile 22 through a dedicated hole and location for capture and containment.

Changes can be made in the above constructions without departing from the scope of the invention. It is intended that all matter contained in the above description or shown in the accompanying drawings shall be interpreted as illustrative and not in a limiting sense. Various other embodiments of the present invention are contemplated as being within the scope of the filed claims particularly pointing out and distinctly claiming the subject matter regarded as the invention.

1. A removable cover for a vehicle comprising:
a) a flexible cover with a number of edges, and a plurality of corners joining the edges; and
b) a plurality of connector devices disposed on the cover that are adapted to engage a surface of the vehicle to secure the cover to the surface of the vehicle.

2. The cover of claim 1, wherein the connector devices are magnets.

3. The cover of claim 2, wherein the cover comprises a plurality of pockets formed thereon that receive the plurality of connector devices.

4. The cover of claim 3, wherein the pockets are formed at least partially with a protective fabric.

5. The cover of claim 2, wherein the magnets are positioned within side edges of the cover and at each corner of the cover.

6. The cover of claim 5, wherein the plurality of connector devices engage at least one side of the vehicle.

7. The cover of claim 5, wherein one of the side edges engages a dash of the vehicle located underneath a windshield.

8. The cover of claim 7, wherein the cover substantially covers an open cockpit recess of the vehicle.

9. The cover of claim 2, wherein the cover is made a translucent material.

10. The cover of claim 9, wherein the translucent material is UV opaque.

11. The cover of claim 1, wherein the cover has a plurality of vent holes formed therein.

12. The cover of claim 1, wherein the cover is made at least partially of a breathable mesh material.

13. The cover of claim 1, wherein the cover has a water drainage hole.

14. A cover for a convertible automobile comprising a plurality of connector devices within the cover that releasably engage at least one side of the automobile when a convertible top of the automobile is in a retracted position, wherein the cover is dimensioned to cover an open interior of the automobile.

15. The cover of claim 14, wherein the connector devices are magnets.

16. The cover of claim 15, wherein the connector devices are retained within pockets on the cover formed with a soft fabric material.

17. A method of applying a temporary cover to a vehicle comprising:
a) providing the temporary cover of claim 1;
b) aligning a first edge of the temporary cover with a windshield of the vehicle; and
c) engaging a plurality of connector devices contained within the temporary cover with an exterior surface of the vehicle.

18. The method of applying a temporary cover of claim 17, wherein the connector devices are magnets.

19. The method of applying a temporary cover of claim 17, wherein the temporary cover is engaged with a dashboard of the vehicle under the windshield of the vehicle.

20. The method of claim 17 wherein the step of engaging the plurality of connectors comprises aligning a second edge of the temporary cover containing the connector devices with the exterior surface of the vehicle.
